(19) United States
(12) Patent Application Publication
(10) Pub. No.: US 2003/0001858 A1
(43) Pub. Date: Jan. 2, 2003

(54) Creation of a mosaic image by tile-for-pixel substitution

(76) Inventor: Thomas Jack, Pully/Lausanne (CH)

Correspondence Address: John MOETTELI, BUGNION S.A., Case postale 375, Geneva, 1211, CH

(21) Appl. No.: 10/164,303

(22) Filed: Jan. 16, 2002

Related U.S. Application Data
(60) Provisional application No. 60/262,576, filed on Jan. 18, 2001.

(51) Int. Cl. G09G 5/00

(52) U.S. Cl. 345/582

(57) ABSTRACT

A target mosaic image is created by replacing each pixel in a smaller source image with an appropriately colorized tile image. Tiles may repeat, be non-square and/or non-rectangular, and be multi-sized. For artistic effect, selected areas of the target image may be excluded from tiling on the basis of user-supplied criteria. This methodology is in marked contrast to all other known methods for creating mosaic images (including the well-known method of Robert Silvers [U.S. Pat. No. 6,137,498], wherein the best match to the attributes of target regions/subregions are sought from a library of tile image candidates). Claims are also made with regard to several methodologies which support the mosaic image creation. These claims include a methodology for positioning tiles which minimizes eye-detectable patterns of repeat images, a process for tile multi-sizing such that inappropriate sizes are not positioned to the detriment of the output image, a method for colorizing tiles, a method for automatically adjusting image lightness and contrast, an image resizing methodology, and a pattern-recognition algorithm for the automatic creation of tile images.

### BACKGROUND OF THE INVENTION

This invention relates to graphics software and, more particularly, to graphics software that implements a method of creating a mosaic image.

Other known methods for creating mosaic images (including the well-known method of Silvers, U.S. Pat. No. 6,137,498) attempt to select a best match to the attributes of target regions/subregions from a library of tile image candidates. Such a selection requires significant computer resources due to a step in which a match to the attributes of target regions/subregions from a library of tile image candidates is sought.

Therefore, what is needed is a method which is simpler to implement and which requires less computer resources.

### SUMMARY OF THE INVENTION

This method creates the mosaic image by replacing each pixel in a smaller source image with an appropriately colorized tile image. In a submethod of the method, tiles are positioned in such a way as to minimize eye-detectable patterns of repeat images. In another submethod of the invention, a process for tile multi-sizing such that inappropriate sizes are not positioned to the detriment of the output image. In another submethod, a tile colorizing method is provided. In another submethod, a method for automatically adjusting image lightness and contrast is provided. In another submethod, an image resizing methodology is provided. In another submethod, a pattern-recognition algorithm is provided for the automatic creation of tile images.

An object of the invention is to reduce necessary computer resources by eliminating a step in which a match to the attributes of target regions/subregions from a library of tile image candidates is sought.

### BRIEF DESCRIPTION OF THE DRAWINGS

FIG. 1 is a flow chart of the method of the preferred embodiment.

FIG. 2 is a flow chart of the tile creation submethod of the preferred embodiment

FIG. 3 is a screen print of a control interface of the invention.

FIG 4 is a flow chart of the source-for-output image creation submethod of the invention.

FIG. 5 is a screen print of another control interface for defining the source-for-output image of the invention.

FIG. 6 is a screen print of another control interface for setting image parameters.

FIGS. 7a and 7b are examples of different tiling formats possible with the invention.

FIG. 8 is an example of the effect of nonadjacent tiling.

FIG. 9 is an example of the effect of excluding files which lack or possess a certain characteristic.

FIG. 10 is a process flow chart of the tile positioning submethod of the invention.

FIG. 11a and 11b are examples of random and non-random tile multi-sizing.

FIG. 12 is a flow chart of the tile sizing submethod of the invention.

FIG. 13 are examples of tile-image candidates for use with the method of the invention.

FIG. 14 is an example of the selection of a prototype tile.

FIG. 15 shows the positioning of a first possible tile and a last possible tile, which make up an output image of the invention.

FIG. 16 is a panel showing source and target tile colorization, in grey scale representation. The left image is pink and the right image is orange-yellow.

FIG. 17 is a panel of an example resulting in improved tile colorization. The upper and lower left images are pink. The right side images are light green.

### DETAILED DESCRIPTION OF THE PREFERRED EMBODIMENT

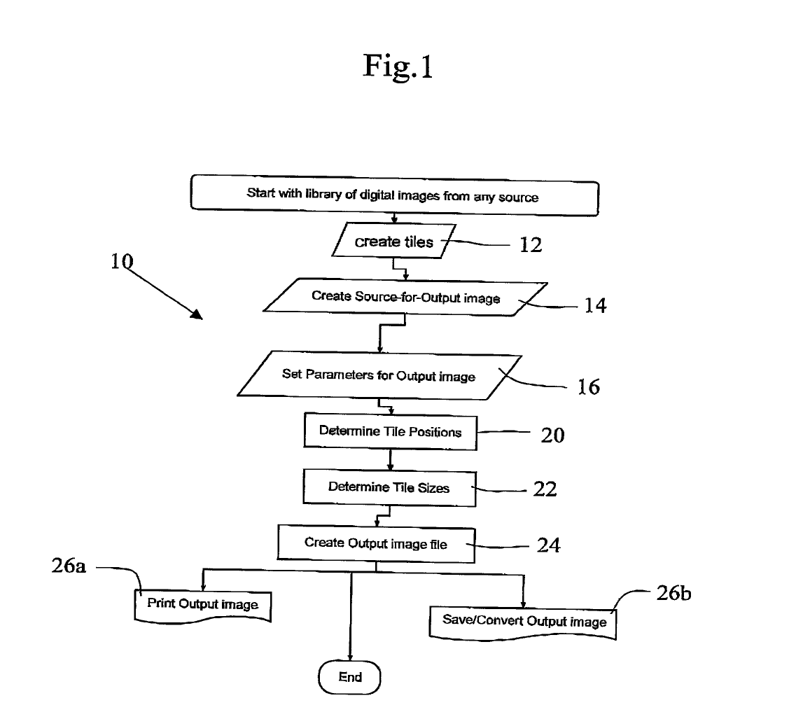

Referring to FIG. 1, the method of the invention creates the mosaic image by replacing each pixel in a smaller source image with an appropriately colorized tile image. In a first step 12, the method 10 creates tiles using a library of digital images from any source. In a second step 14, the source image that will generate the output image is created or selected from among the tile images. In a third step 16, the parameters for the output image are set. In a fourth step 20, the positions for the tiles are determined. In a fifth step 22, the sizes for the tiles are determined. In a sixth step 24, the output image is created. In optional sixth steps 26a, 26b, the output image is printed, saved, or converted.

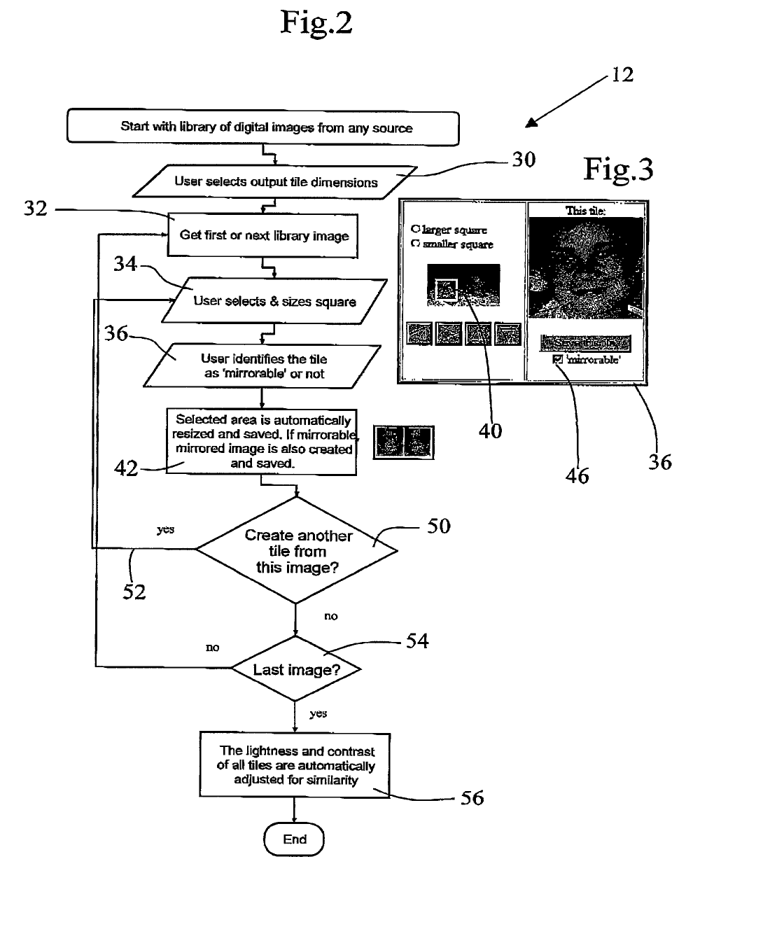

Referring now to FIG. 2, a tile creation step 12 includes several substeps. In a first substep 30, the user selects the output tile dimensions. In a second substep 32, the first or next library image is retrieved from the library of digital images. In a third substep 34, the user is provided with an interface 36 (shown in FIG. 3) to select and size a square of a selected area 40 of a candidate tile image 42 to define the tile size and the information about that square selection is saved in memory, e.g., the user sized, selected, and “saved” a square of 53×53 pixels starting at coordinate 24, 62 of the original image. In a fourth optional substep, the interface 36 provides a designation tick box 46 enables the user to designate a tile as mirrorable. In a fifth substep 44, the selected area 40 is automatically resized and saved and if mirrorable, a mirrored image is created and also saved. In a sixth substep 50, the user is queried as to whether to create another tile from the same image. In a seventh substep 52, if the user makes a selection so as to indicate his desire to create another tile image from the same image, the submethod returns to the third substep 34 and continues. In the user fails to indicate his desire to create another tile image using the same image, in substep 54, the submethod queries the user if this is the last image. If not, the submethod goes to substep 34 and continues. If yes, in substep 56, the lightness, contrast and color of all tiles are automatically adjusted for similarity with the characteristics of the pixel of the Source-for-Output image that the tile is replacing (described in more detail below).

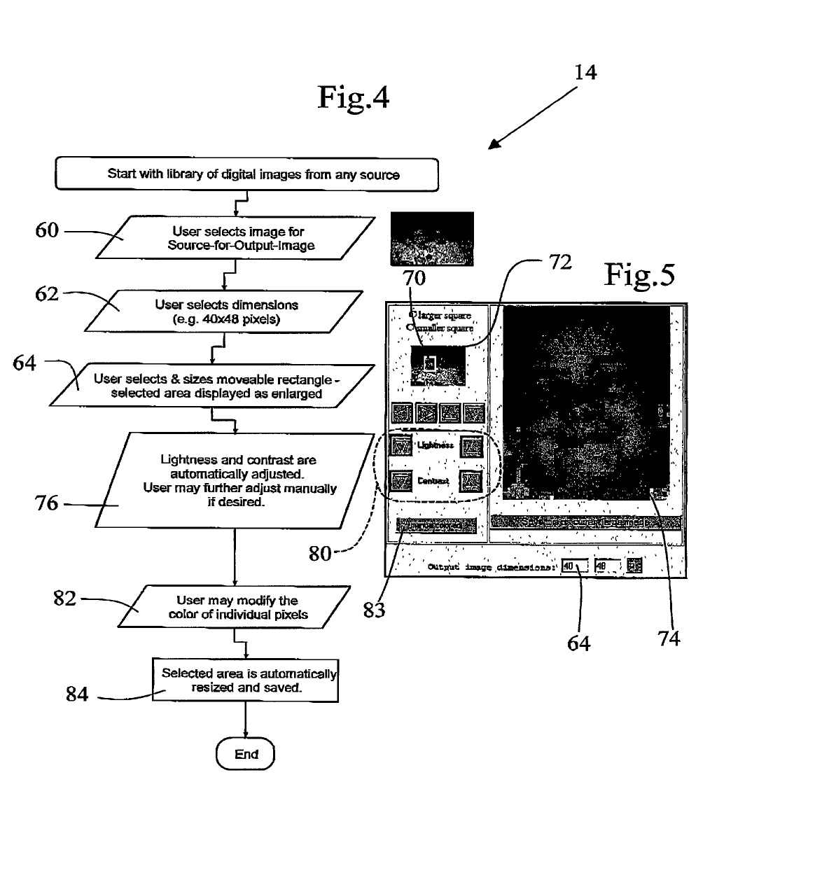

Referring now to FIG. 4, a flowchart of the source-for-output image creation submethod 14 is shown. In a first substep 60, the user selects an image 62 (shown in FIG. 5) for the Source-For-Output image. In a second substep 62, using the data input fields 64 and 66 (shown in FIG. 5), the user selects dimensions (e.g., 40×48 pixels, as shown). In a third substep 64, the user uses a rectangular icon 70 (shown in FIG. 5) to select and size an area 72 that is enlarged in an adjacent window 74 (shown in FIG. 5). In a fourth substep 76, using controls 80, lightness and contrast may be manually or automatically adjusted. In other words, lightness and contrast may simply be adjusted to target values using ordinary adjustment techniques. In a fifth substep 82, if not already performed, using controls 83, the user may optionally modify the color of individual pixels. In a sixth substep 84, the selected area is automatically resized and saved.

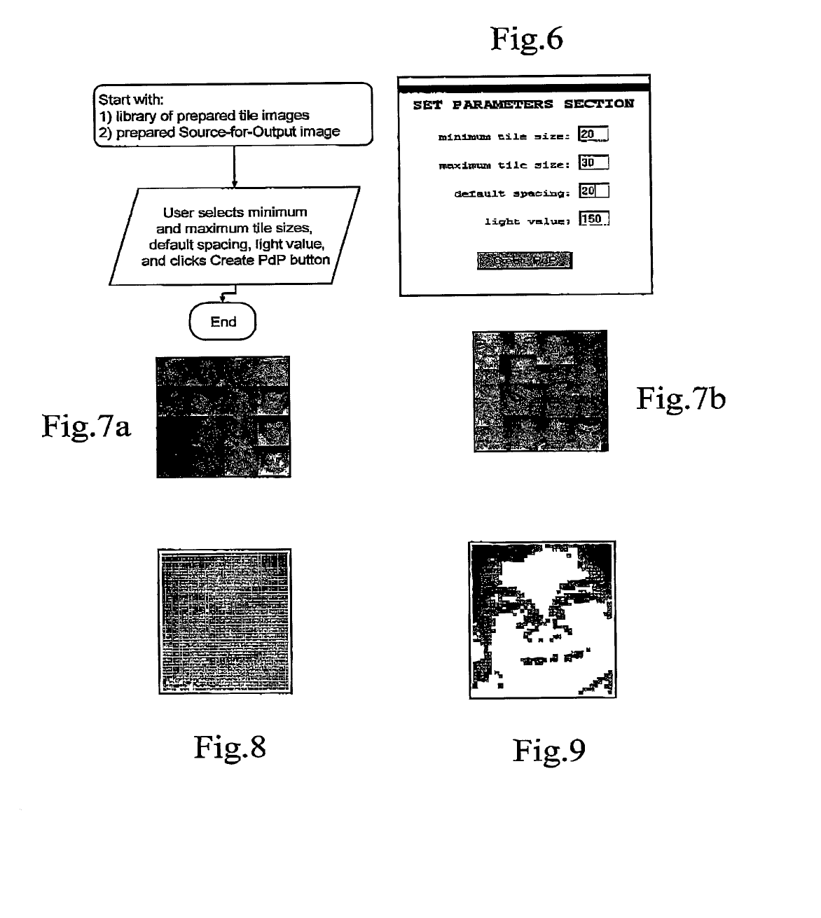

Referring now to FIG. 6, after preparation of the file images and the Source-for-Output image, the user, using a set parameter interface 86 sets parameters that will determine the size and attributes of the Output image. If uniform tile sizing is desired, then the minimum tile size must equal the maximum tile size. FIGS. 7a and 7b, respectively, show an example of uniform and non-uniform tile sizing. As shown in FIG. 8, an example of tiling having spacing between adjacent tiles is shown (spacing factor>minimum tile size). If no space is desired between tiles, then the default spacing value must equal the minimum tile size. Referring to FIG. 9, the user may elect to not include tiles below a specified “light” value, or define some other user-supplied criteria upon which to decide whether or not tiles should appear in the image. In this example, all “light” values greater than 150 are excluded for artistic effect. For better comprehension, it is noted that “0” is black and “255” is white. Essentially therefore, pixels in the Source-for-Output image whose grey values (GVs, 0-255) are greater than, or lighter than, 150 are excluded from tile-substitution.

A tile is assigned to each pixel of the Source-for-Output image. If there are more tiles than pixels, then all the tiles cannot be used, and the tiles are randomly assigned to each pixel coordinate. If there are more pixel coordinates than tiles, then tiles must be repeated. The purpose of this algorithm is to position the tiles such that repeated tiles are as far apart as possible while avoiding any eye-detectable placement pattern. This is a completely automated process. In an optional submethod, between the steps of selecting a source image for enhancement and reading selected pixels of the source image, the source image may be processed to yield the desired resolution and thus the desired pixel size. For example, if the desired resolution of the target image is 50×50 pixels, and the Source-for-Output resolution is 200×200 over the same graphic area, then the optional submethod averages the characteristics of four adjacent pixels to create a pseudo-pixel from which further processing as described below may be performed. In other words, four adjacent pixels are considered as one large pixel for the purpose of creating the mosaic image.

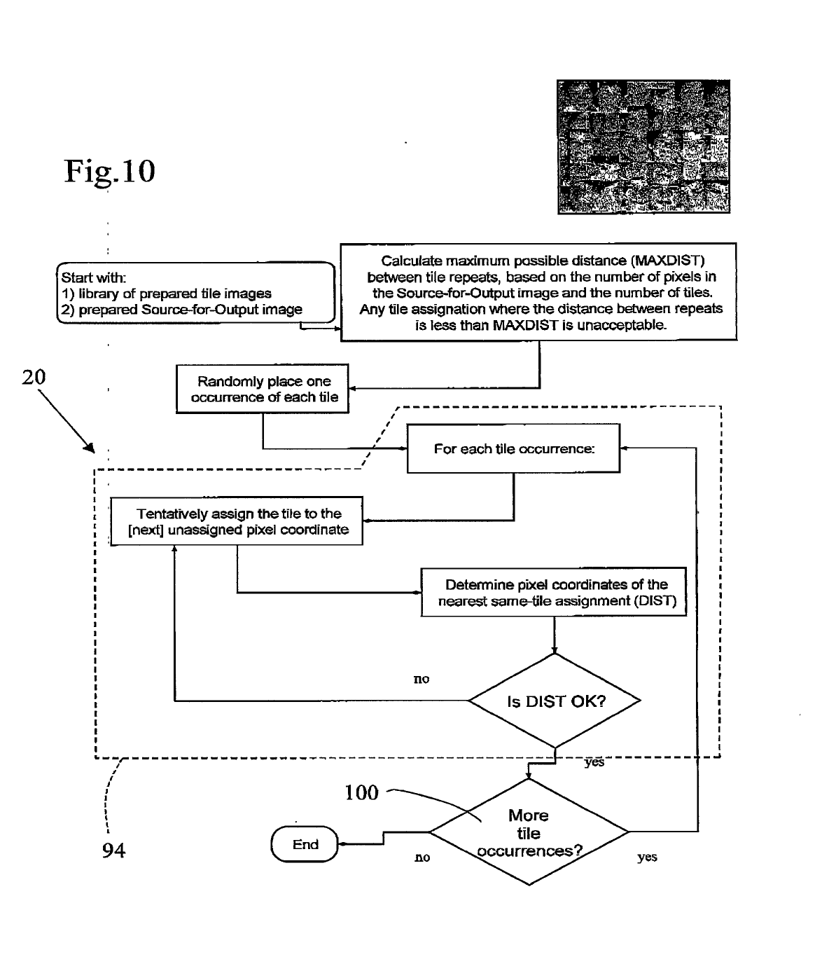

Referring now to FIG. 10, the fourth step 20 for determining the positions for the tiles which minimises eye-detectable patterns of repeat images is shown. In a first substep 90, the submethod 20 calculates maximum possible distance (MAXDIST) between tile repeats, based on the number of pixels in the Source-for-Output image and the number of tiles. Any tile assignation where the distance between repeats is less than MAXDIST is unacceptable. In a second substep 92, one occurrence of each tile is randomly placed. In a third substep 94, a for-loop is executed. In this loop, for each tile occurrence, the tile is tentatively assigned to the [next] unassigned pixel coordinate and then, the nearest same-tile assignment (DIST) is determined. If the DIST is lesser than MAXDIST, then the loop returns to the next unassigned pixel coordinate and continues in the for-loop. If DIST is OK, then, in a third substep 100, the submethod 20 asks the user whether there are more tile occurrences. If yes, then the submethod 20 returns to the beginning of the for-loop 94.

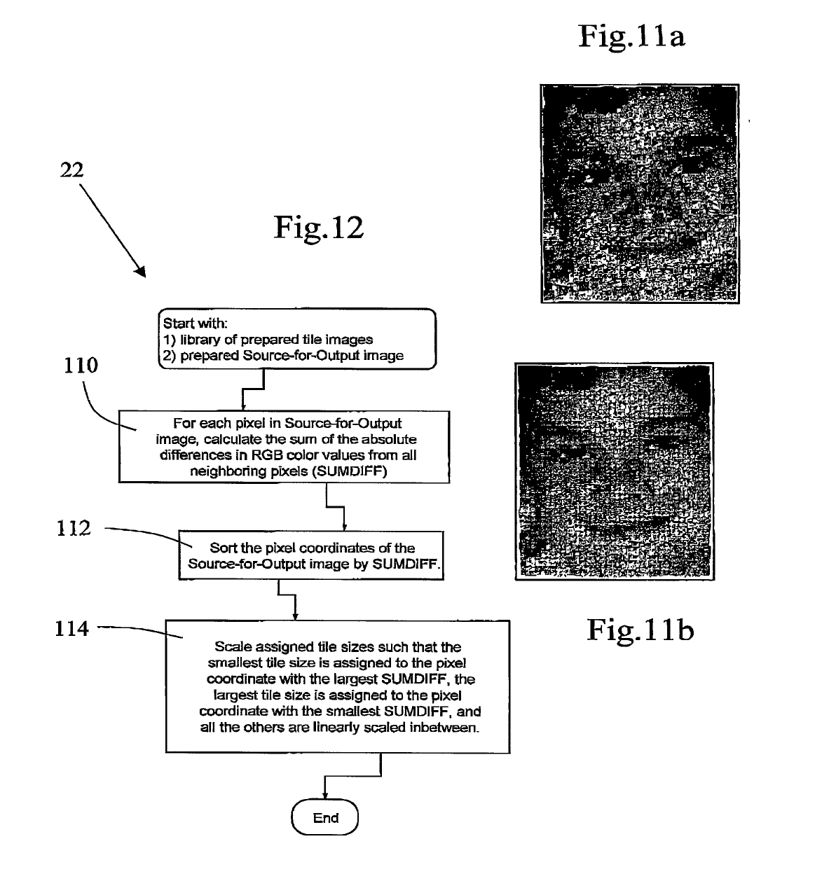

A tile size is assigned to each pixel coordinate. When the user elects non-uniform tile sizing, tile sizing is not random. If it were random, larger tiles may be positioned inappropriately to the detriment of the output image. An example of an image having had random tile multi-sizing is shown in FIG. 11a. An example of an image having had non-random tile multi-sizing is shown in FIG-11b. Tile multi-sizing helps ensure that that inappropriate sizes are not positioned to the detriment of the output image.

Referring now to FIG. 12, the fifth step 22 of the method 10 is comprised of several substeps. In a first substep 110, for each pixel in the Source-for-Output image, the sum of the absolute differences in RGB color values is calculated from all neighbouring pixels (SUMDIFF). In a second substep 112, the pixel coordinates of the Source-for-Output are sorted by SUMDIFF. In a third substep 114, a scale is assigned to tile sizes such that the smallest tile sized is assigned to the pixel coordinate with the largest SUMDIFF, the largest tile size being assigned to the pixel coordinate with the smallest SUMDIFF, and all the others are linearly scaled in-between.

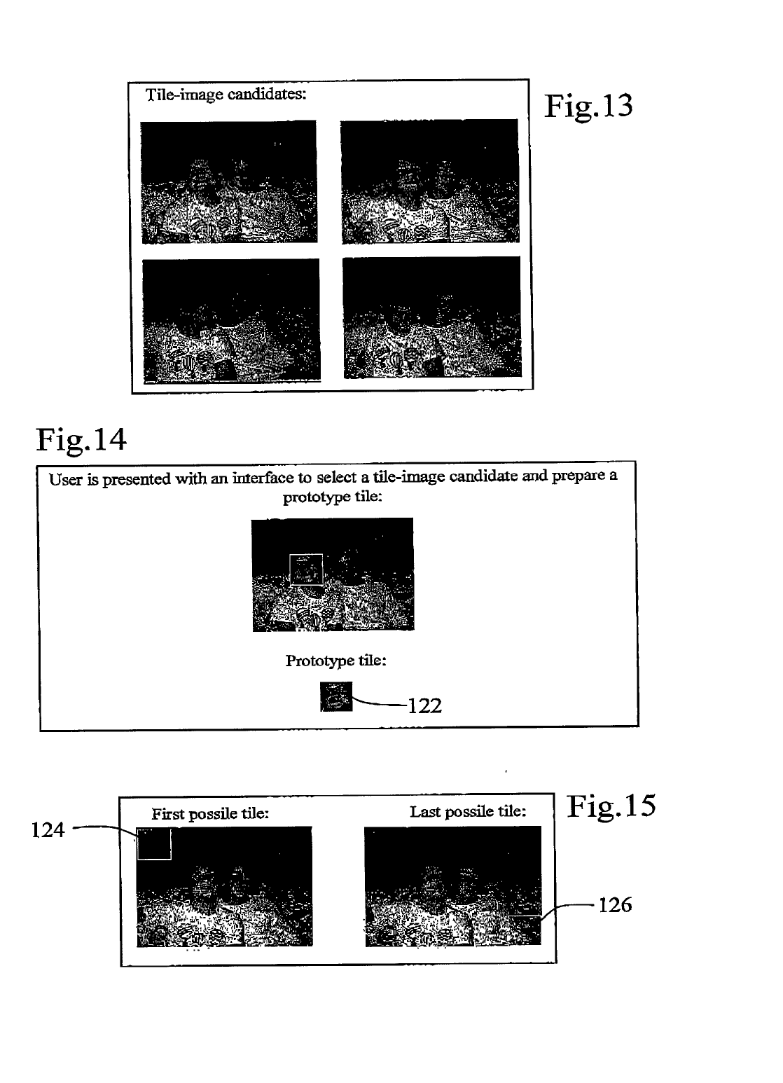

Referring now to FIGS. 13-15, a pattern-recognition algorithm is provided for the automatic creation of tile images. The pattern-recognition algorithm automatically as creates tiles from similar source images, typically human portraits. Referring to FIG. 13, four tile-image candidates are shown. Referring to FIG. 14, the user is presented with an interface 120 to select a tile-image candidate and prepare a prototype tile 122.

For the prototype tile 122, the R, G, and B values are rounded to a pre-selected number, e.g. 50. For instance, the rounded color values for a pixel of RGB(126,88,220) would be RGB(150,100,200). The frequency distribution of rounded colors is remembered by the program (e.g., RGB(150,100,200) occurs 17 times in the prototype tile). Invisible to the user, the method then loops through each remaining tile-image candidate, performing the following substeps. In a first substep, starting at the upper left corner, each possible tile of the same size as the prototype tile 122 is selected. FIGS. 15a and 15b show the fist and last possible tile positions 124 and 126 respectively. In a second substep, for each possible tile, the distribution of rounded color values is calculated in the same manner as for the prototype tile. In a third substep, the possible tile which is most similar to the prototype tile on the basis of rounded color distribution is selected as the tile for that tile-image candidate. Similarity judgement is based on Mean Average Deviation (MAD). For example, if RGB(150,100,200) occurs 17 times in the prototype image and 20 times in the possible file, then the absolute difference for this rounded color value is 3. The absolute differences for all rounded color values are summed for each possible tile, and the possible tile with the smallest absolute difference is deemed the most similar. Note that in order to speed processing, the user may elect to not consider all tile possibilities. In a fourth substep, the user is presented with the auto-tiles selected. The interface (not shown) allows the user to delete a file by right-clicking it, or to adjust the square by ‘directional’ clicking—e.g., clicking in the bottom-left of the middle tile would adjust the square down and to the left. The user may then click to save tiles when finished with deletions/adjustments.

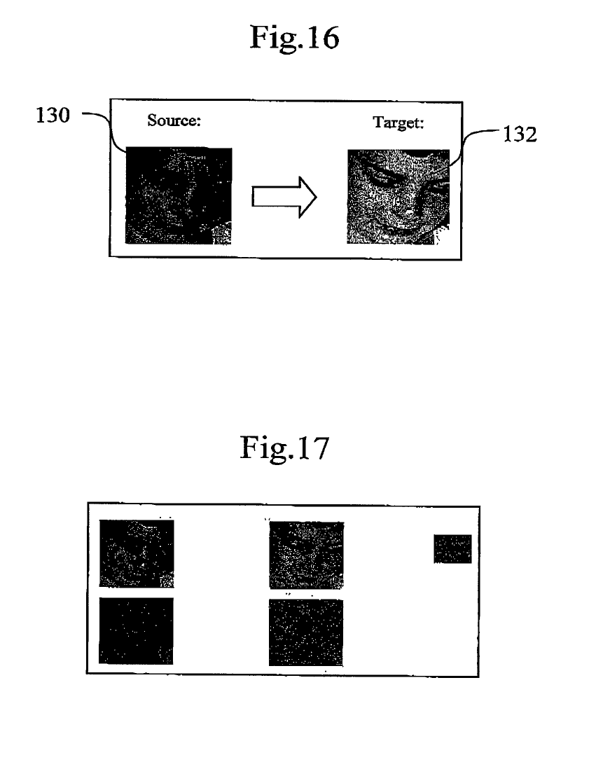

Referring now to FIGS. 15-17, the tile colorization process will be described in more detail. This process is a relatively complex and important subprocess of the invention. After the user has selected a subset of an image as his Source-for-Output image, the color of each pixel in the Source-for-Output image will become the target color of a tile. Since the tile itself is composed of many colors, the goal of the tile colorization process is to colorize the tile such that its overall color impression is that of the target color.

In order to colorize an individual tile pixel, the following are needed:

the target RGB

the overall GV of the tile to be colorized

the GV of the individual tile pixel to be colorized

The RGB values of each pixel in the tile is colorized according to the following algorithm:

Target tile color value=target color value−(uncolorized tile avg GY—this tile pixel GV)

For example:

The target color for a tile is RGB(214,162,66).

For the tile to be colorized, the average uncolorized GV is 172.

The uncolorized color values for the tile point to be colorized is RGB(110,120,130). The GV is 120.

The R value for this tile point will be R=214−(172−120)=162

The G value for this tile point will be R=162−(172−120)=110

The B value for this tile point will be R=66−(172−120)=14

The colorized RGB value for the tile point will be RGB(162,110,14).

Any calculated R, B, or B value which is less than 0 is changed to 0, and every calculated R, B, or B value which is greater than 255 is changed to 255. Note that any colorization methodology will suffice as long as 1the colorized tile is a visual match with the point color from the Source-for-Output image. This algorithm works particularly well for colorizing tiles which are extremely light or extremely dark. This is important, especially with white points in the Source-for-Output image, which could appear as pictureless tiles with an ineffective algorithm.

Note as well that better tile colorization is achievable with reduced contrast. Consider the example of FIG. 18. There is a tradeoff between tile clarity and effective tile colorization. The more complex the Source-for-Output image, the greater need for effective tile colorization. Portraits tend to be less complex images, with sharper tiles more important than perfect tile colorization. Often, a desirable “ghostly” effect is achieved with very low-contrast tiles (i.e., one must study the large output mosaic to even notice that the tiles represent images). This may be achieved via a user selectable interface or by manually adjusting the tile contrast internally to achieve this special effect.

Multiple variations and modifications are possible in the embodiments of the invention described here. Tiles may repeat, be non-square and/or non-rectangular, and be multi-sized. For artistic effect selected areas of the target image may be excluded from tiling on the basis of user-supplied criteria. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A method for creating a target mosaic image, the method comprising the steps of:
(a) selecting a source image for enhancement;
(b) reading selected pixels of the source image; and
(c) creating the target mosaic image patterned upon the source image by replacing pixels with image tiles having color characteristics corresponding to pixels in the source image.

2. The method of claim 1 wherein a subroutine which minimizes repeat patterns of image tile positioning is applied between steps (b) and (c).

3. The method of claim 1 wherein, after step (c), the image tile's size is reconciled to differing color distribution within the source image.

4. The method of claim 1 wherein, between steps (a) and (b), the source image is processed to yield the desired resolution and thus the desired size in pixels.

5. The method of claim 1 wherein the target mosaic image is resized with respect to the source image.
